(19) United States
(12) Patent Application Publication
(10) Pub. No.: US 2012/0330507 A1
(43) Pub. Date: Dec. 27, 2012

(54) INTERFACE FOR CYCLING THROUGH AND SELECTIVELY CHOOSING A MODE OF A VEHICLE FUNCTION

(75) Inventors: David Bruce Auner, Ann Arbor, MI (US); Earnee Yasha Jones, Ypsilanti, MI (US)

(73) Assignee: TOYOTA MOTOR ENGINEERING & MANUFACTURING NORTH AMERICA, INC., Erlanger, KY (US)

(21) Appl. No.: 13/551,336

(22) Filed: Jul. 17, 2012

Related U.S. Application Data
(63) Continuation-in-part of application No. 12/340,884, filed on Dec. 22, 2008.

(51) Int. Cl. G06F 19/00

(52) U.S. Cl. 701/36

(57) ABSTRACT

A system and method for cycling through and selectively choosing one of a number of predetermined modes of a vehicle function. The system includes an interface. The predetermined number of modes are arranged in a cyclic arrangement, wherein each mode is in a fixed relationship with the others. The interface is operable to index through the cyclic arrangement to return to the initial mode. The interface includes an interface body and a display. The display includes a plurality of indicators which indicate which vehicle system is being actuated. The interface is operable to cycle through and selectively choose one of a number of predetermined modes of the vehicle's ventilation system using the same motion. In a preferred embodiment, the interface is a button, which upon pressing indexes through a predetermined cyclic arrangement of predetermined modes and actuates the selected predetermined mode.

### CROSS-REFERENCE TO RELATED APPLICATIONS

This Application is a Continuation-in-part of application Ser. No. 12/340,884 filed on Dec. 22, 2008, the contents of which is incorporated herein by reference in its entirety.

### BACKGROUND OF THE INVENTION

The present invention relates generally to an interface for cycling through and selectively choosing one of a number of predetermined modes of a vehicle function. More specifically the interface is operable to cycle through and selectively choose one of a number of predetermined modes of the vehicle's ventilation system.

### DESCRIPTION OF THE RELATED ART

Vehicles are equipped with interfaces for selectively choosing different modes of a vehicle function. For instance the instrument panel will typically include a configuration of dials and buttons each operable to adjust different vehicle systems such as the heating, the radio, air conditioning and the like. Instrument panels also include other displays such as a speedometer, a land navigation display, a fuel gauge, and the like. These displays and interfaces may clutter the instrument panel making it confusing to the vehicle operator. Furthermore, some interfaces like the one shown in FIG. 1, require separate controls for each mode, and thus unnecessarily occupy instrument panel space. Therefore it is desirable to have a vehicle instrument panel which is configured so as to minimize the clutter and enable the user to be able to readily identify a function and operate it in a simplistic manner.

Furthermore, some of the vehicle controllers require the operator to use different motions in order to selectively toggle through various different modes of vehicle functions and a different motion to selectively choose one of the vehicle modes. Accordingly it is desirable to have a vehicle interface for selectively choosing one of a predetermined number of vehicle modes using a simple motion so as to enable the operator and others that are not familiar with the vehicle to easily operate the vehicle system.

### SUMMARY OF THE INVENTION AND ADVANTAGES

The present invention provides a system and method for operating a vehicle system, wherein the system is operable to function in one of a plurality of predetermined modes. The system includes an interface operable to cycle through and actuate one of the plurality of predetermined modes. The interface comprises an interface body having a display. The display includes a plurality of indicators, each indicator is associated with one of the plurality of predetermined modes so as to indicate which mode the vehicle system is operating in. The selected predetermined mode is indicated by the corresponding indicator.

### BRIEF DESCRIPTION OF THE DRAWING

A better understanding of the present invention will be had upon reference to the following detailed description when read in conjunction with the accompanying drawing wherein like reference characters refer to like parts throughout the several views and in which:

FIG. 1 is a view illustrating a prior art interface for choosing airflow;

FIG. 2 is a view illustrating an embodiment of an interface operable to cycle through and selectively choose one of a number of predetermined modes of operation of the vehicle's ventilation system by performing the same motion, namely by pressing the interface;

FIG. 3a-3c is an illustration of an interface indexing through and actuating the indexed predetermined modes, wherein the interface is a touch screen display;

FIG. 4 is an illustration of an interface operable to cycle through and selectively choose one of a number of predetermined modes of operation, wherein the interface is a button; and

FIG. 5 is an illustration of an interface operable to cycle through and selectively choose one of a number of predetermined modes of operation of a vehicle system using a voice command.

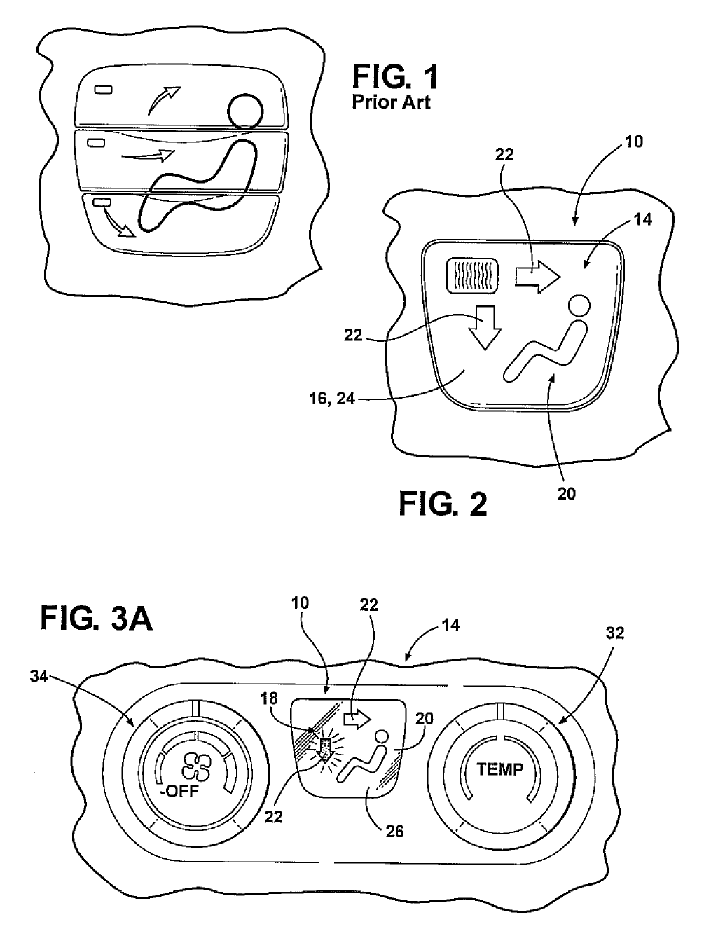

### DETAILED DESCRIPTION OF THE INVENTION

Referring to the figures, wherein like numerals indicate corresponding parts throughout the several views, an interface 10 for operating a vehicle system, wherein the system is operable to function in a predetermined modes 14. The interface selectively chooses and cycles through a number of predetermined modes of a vehicle system using one motion.

Vehicles are known to be equipped with various systems to control functions such as heating and cooling, windshield wiper operation, and the like. Each of these functions may operate in different modes. For example, the heating and cooling system may distribute air to the passenger's head, feet, or body, or direct air to blow on to a window to remove condensation or frost from the window. Another example of a vehicle system is the windshield wiper operation, wherein the wipers may be operable to perform at different speeds. Thus each mode presents a different operating speed to accommodate different precipitation conditions.

With reference first to FIG. 2, an interface 10 for operating a vehicle system wherein the system is operable to function in a number of predetermined modes 14 is provided. The modes as used herein refer to the flow of air from conduits directed towards the occupant's feet, head, or both as indicated by the arrows. For illustrative purposes, the interface 10 is shown to actuate the vehicle's HVAC system. However, it is anticipated that the interface 10 may be used to actuate other vehicle systems such as the wipers, or the radio.

The interface 10 includes an interface body 16 having a display 18. As shown in FIG. 2 the interface 10 a button 20 operable to cycle through and selectively choose one of a number of predetermined modes 14 of the vehicle's ventilation system. The interface 10 includes an interface body 16 having a display 18. The display 18 includes a plurality of indicators 22, shown as arrows, which indicate the mode the vehicle system is operating in. The interface 10 is operable to cycle through each of the predetermined modes 14 and selectively chooses one of the predetermined modes 14 by merely pressing the interface 10.

A predetermined cyclic arrangement 24 is included. The predetermined cyclic arrangement 24 includes each of the predetermined modes 14. The predetermined modes 14 are arranged within the predetermined cyclic arrangement 24 so as to be in a fixed relationship with each other. Accordingly, the interface 10 may index through each of the modes so as to return to an initial start point.

In the present example each of the indicators 22 is illuminated so as to indicate which mode has been chosen. For example when none of the indicators 22 are illuminated the interface 10 is indicating that the ventilation system is not operating. However, when the lower arrow is illuminated, the system is indicating that air is being distributed towards the feet of the passenger.

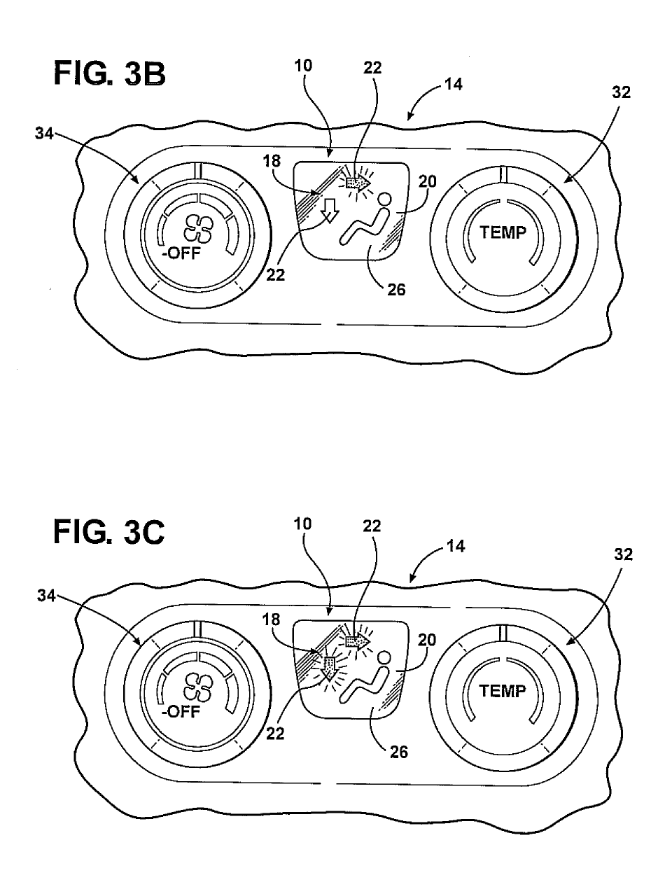

With reference now to FIGS. 3a-3c the operation of the interface 10 will be illustrated. The interface is shown actuating a vehicle ventilation system as indicated by the dial displaying a fan, indicating fan speed, and another dial labeled temperature, indicating the desired temperature. The ventilation system may include a processor 15 and a database 17. The database 17 includes a plurality of modes 14 arranged in a cycle, each of the plurality of modes 14 executes a distinct operating condition of the vehicle ventilation system. Further, each of the plurality of modes is arranged in a fixed order with respect to each other.

The interface is configured to actuate the processor so as to scroll through each of the plurality of modes 14. When the processor initiates scrolling by first selecting the first of the plurality of modes and proceeds to the last of the modes 14, and then returns to the first again following the last of the plurality of modes. The processor continues to scroll through the modes until the user disengages the interface wherein the selected mode 14 is actuated.

In operation the user simply actuates the interface 10 using one simple motion. The interface 10 is shown, in FIGS. 3A-3C, as a touch screen 26, and is operable by simply touching the touch screen 26. When the button 20 is touched the system cycles to the first of the predetermined modes 14 herein indicated by an arrow pointing to the feet of the passenger.

Upon being touched the lower arrow is illuminated so as to indicate to the user that the vehicle's ventilation system will begin blowing air to the feet of the passenger as indicated by illuminated arrow on the display 18, as shown in FIG. 3a. Upon touching the interface 10 again, the interface 10 cycles through to the next predetermined mode 14 in the predetermined cyclic arrangement 24, wherein the upper arrow is illuminated so as to indicate to the operator that the ventilation system will direct air towards the upper body of the passenger as shown by illuminated arrow on the display 18 in FIG. 3b. Upon touching the interface 10 a third time both the feet and the upper body arrows are illuminated thereby showing the operator that the ventilation system is directing air at both the feet and the upper body portion of the passenger. Finally upon touching the interface 10 a fourth time the interface 10 returns the system to the beginning of the cycle wherein the ventilation system is turned off. Thus neither arrow is illuminated indicating to the passenger that the ventilation system is off.

It is anticipated that other modes may be added to the display 18. For instance, the display 18 may include a defrosting symbol as shown in FIG. 2. The defrosting symbol may also be illuminated in conjunction with one of any other of the indicators 22 so as to indicate the different operational modes of the ventilation system. Accordingly, the defroster is a mode included in the predetermined cyclic arrangement 24, and as described above may be actuated in combination with any one of the other modes.

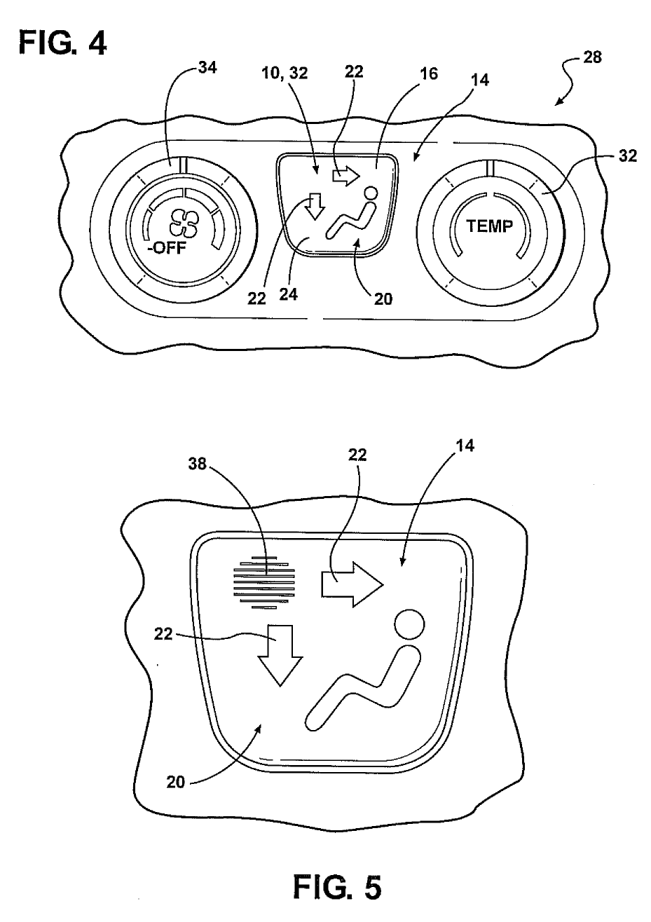

With reference now to FIGS. 3a-3c, and 4, the interface 10 is shown as part of a control module 28 for a vehicle ventilation system. The control module 28 is disposed on the vehicle's instrument panel and includes a first interface 30 for controlling the intensity of the fan, and a second interface 32 for controlling the temperature of the air. The interface 10 is the third interface 34 on the control module 28 and is shown disposed between the first and second interface 30, 32. The third interface 34 is operable as described above, and can cycle through the predetermined cyclic arrangement 24 to selectively choose one of the predetermined modes 14. The selected mode is then illuminated on the interface's 10 display 18 by the corresponding indicator 22.

With reference now to FIG. 4, a control module 28 wherein the interface 10 is a button 20 is provided. As described above, the button 20 is operable to automatically cycle through the predetermined modes 14 with push. Specifically the operator pushes the button 20 once, and the individual indicators 22 are illuminated so as to indicate which mode is currently being actuated. The interface 10 will index through each of the modes, and progresses to the next mode after a predetermined period of time. Thus the user has an opportunity to release the button 20 upon the illumination of a desired mode.

With reference now to FIG. 5, a third preferred embodiment the interface 10 is provided wherein the interface 10 is voice activated by a predetermined voice command such as “cycle.” Thus the interface 10 is operable to cycle through and selectively choose one of the predetermined modes 14 by receiving the voice command. In operation when the user says the predetermined voice command, the interface 10 will index through the cycle of predetermined modes 14 to the first mode within the predetermined cyclic arrangement 24 and actuate the indexed mode. The actuated mode is indicated in the display 18 by the illumination of the corresponding indicator 22. If the operator desires a different mode, the operator will say the voice command and the interface 10 will index the predetermined cyclic arrangement 24 to the next mode, actuate the indexed mode and illuminate the corresponding indicator 22.

A method for operating a vehicle system is also provided. The method includes providing an interface 10 having an interface body 16 including a display 18, providing a plurality of indicators 22 on the display 18 wherein each indicator 22 is illuminated so as to indicate which mode is being actuated, establishing a predetermined cyclic arrangement 24, wherein the cyclic arrangement includes each mode of the vehicle function in a fixed relationship with each other, and actuating the interface 10 so as to cycle through each of the predetermined modes 14 and selectively choose one of the predetermined modes 14.

Having described our invention, however, many modifications thereto will become apparent to those skilled in the art to which it pertains without deviation from the spirit of the invention as defined by the scope of the appended claims.

What is claimed is:

1. An interface for operating a vehicle ventilation system, the interface comprising:
a processor and a database, the database having a plurality of modes arranged in a cycle, each of the plurality of modes executing a distinct operating condition of the vehicle ventilation system, each of the plurality of modes arranged in a fixed order, the processor operable to scroll through each of the plurality of modes wherein the processor scrolls through the first of the plurality of modes after scrolling through the last of the plurality of modes;
an interface body, the interface body including a display on an outer surface of the interface body, the interface body operable to be actuated by the touch of a user;
the display including a plurality of indicators, each of the plurality of indicators is associated with one of the plurality of predetermined modes so as to indicate which mode the vehicle system is operating in, wherein a touch of the interface body actuates the processor to index through each of the plurality of modes in sequence, and upon release of the interface body, the selected plurality of modes is actuated, and the selected predetermined mode is indicated by the corresponding indicator.

2. An interface as set forth in claim 1 wherein each of the plurality of predetermined modes is arranged in a predetermined cyclic arrangement, wherein each of the predetermined modes is arranged in a fixed relationship with each other.

3. An interface as set forth in claim 1 wherein each of the predetermined modes represents a predetermined airflow path.

4. An interface as set forth in claim 1 wherein the interface is a button actuated by being pushed such that the system indexes through each of the predetermined modes and actuates the selected predetermined mode with each push.

5. An interface as set forth in claim 4 wherein the button continuously indexes through each of the predetermined modes with one push and wherein the button actuates the indexed predetermined mode when the button is released.

6. An interface as set forth in claim 4 wherein each of the plurality of indicators is illuminated so as to further indicate which one of the predetermined modes is being actuated.

7. An interface as set forth in claim 1 wherein the interface is further actuated by a predetermined voice command, wherein upon receipt of the predetermined voice command, the interface selectively chooses one of the predetermined number of modes.

8. An interface as set forth in claim 1 wherein the interface is a touch screen display actuated by being touched such that the system indexes through each of the predetermined modes and actuates the selected predetermined mode with each touch.

9. A vehicle ventilation system control module for a vehicle instrument panel, the control module operable to selectively choose one of a predetermined modes of airflow, wherein the predetermined modes of airflow are arranged in a predetermined cyclic arrangement, said control module having a first interface for controlling the intensity of the fan and a second interface for controlling the temperature of the air, said control module comprising:
a third interface having an interface body, the interface body having a display, the display on the interface body;
the display including a plurality of indicators, each of the plurality of indicators is associated with one of the plurality of predetermined modes so as to indicate which mode the vehicle system is operating in; and
wherein the third interface is operable to index through the predetermined cyclic arrangement wherein third interface moves to the first of the predetermined modes of airflow after scrolling through the last of the predetermined modes of airflow, and actuate one of the predetermined modes, and wherein the selected predetermined mode is indicated by the corresponding indicator

10. An interface as set forth in claim 9, wherein each of the plurality of predetermined modes is arranged in a predetermined cyclic arrangement, wherein each of the predetermined modes is arranged in a fixed relationship with each other.

11. A method of selectively choosing a particular mode of a vehicle system using the same motion, the method comprising the steps of:
providing an interface having an interface body and a display shown on the interface body,
providing a plurality of indicators on the display wherein each indicator is illuminated so as to indicate which function is actuated;
establishing a predetermined cyclic arrangement, wherein the cyclic arrangement includes each mode of the vehicle function in a fixed relationship with each other;
and actuating the interface so as to cycle through each of the predetermined modes and selectively choose one of the predetermined number of modes.
